(19) United States
(12) Patent Application Publication
(10) Pub. No.: US 2006/0070356 A1
(43) Pub. Date: Apr. 6, 2006

(54) DEVICE AT A SADDLE

(76) Inventor: Ove Ahlgren, Trollhattan (CH)

Correspondence Address: MERCHANT & GOULD PC, P.O. BOX 2903, MINNEAPOLIS, MN, 55402-0903, US

(21) Appl. No.: 10/432,009

(22) PCT Filed: Dec. 14, 2001
(86) PCT No.: PCT/SE01/02796

§ 371 Date: Aug. 29, 2003

(30) Foreign Application Priority Data
Feb. 20, 2001 (SE) 0100560-2

(51) Int. Cl. B68C 1/16

(52) U.S. Cl. 54/46.2

(57) ABSTRACT

The invention relates to a device in a riding saddle for fixing stirrup leathers (5) belonging to the saddle. The device comprises a safety element (1) on each side of the saddle, these being designed as a mirror image of one another and fitted to the saddle. Each safety element comprises an arm (1a), which at its remote end has a pivoted locking pin (1b). The arm (1a) when riding is directed essentially horizontally backwards with the locking pin (1b) pointing upwards in order in normal riding to prevent a stirrup leather, running over the arm (1a), from leaving this. Under increased stress as a result of abnormal circumstances the locking pin (1b) is bent backwards, thereby allowing the stirrup leather (5) to be released. The device further comprises a sleeve (4) that can be threaded on the arm (1a) and having a cut-out (4a), in which the stirrup leather (5) can be connected. The sleeve (4) at its end facing the remote end of the arm (1a) has a projection (4b). This is designed in normal riding to bear against the outer end (1b1) of the upwardly directed locking pin (1b), but under abnormal circumstances is bent backwards. This allows the sleeve (4) to slip off the arm (1a) thereby freeing each stirrup from the saddle.

The present invention relates to a device according to the pre-characterising clause of claim 1.

This safety element briefly described above has been known since the end of the 1800's, its function being to prevent the rider from remaining suspended in one or both of the stirrups in the event of a fall from the horse. This known safety element functions well, provided that the locking pin is so flexible that it really is bent backwards under the forces applied to it by the stirrup leather under abnormal circumstances. For various reasons, however, it happens not infrequently that the locking pin jams, which can have disastrous consequences if the rider falls off the horse. Even if the locking pin moves easily, there nevertheless remains the problem of the stirrup leather giving way or of the pin catching in the leather edge.

The object of the present invention is to at least increase the reliability with which the stirrups are released from the saddle in abnormal circumstances.

According to the invention this is achieved by the features specified in the characterising part of claim 1.

In certain types of saddles, the aforementioned safety element is sunk into a hollow space beneath the surface of the saddle, in certain designs covered by a leather flap, in order to prevent the rider being accidentally caught up or injured thereby, there being a leather edge around the hollow space. The feature specified in claim 2 means that the sleeve according to the invention can be relied upon not to catch in the leather edge.

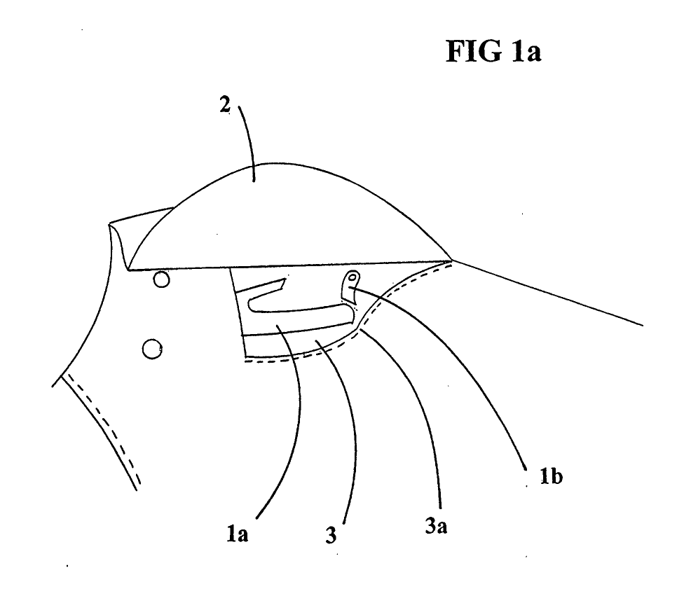

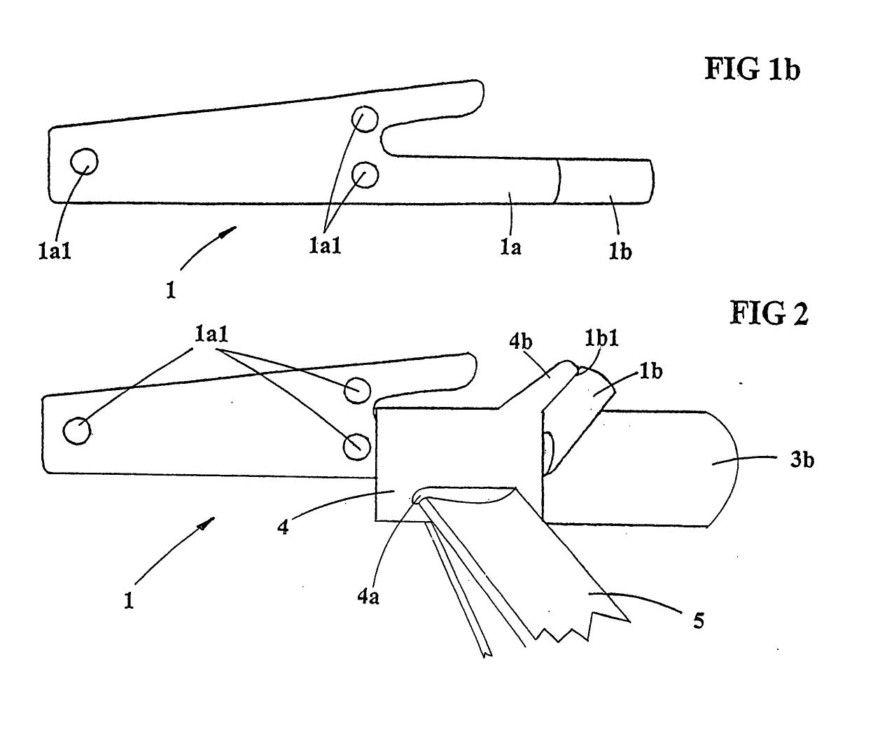

The invention will be explained in more detail below with reference to drawings attached, of which FIG. 1a shows a known design of a safety element fitted to a saddle under a leather flap.

FIG. 1b shows the safety element separately and FIG. 2 shows a plan view from the side of an embodiment of a device according to the invention in situ on the known safety element.

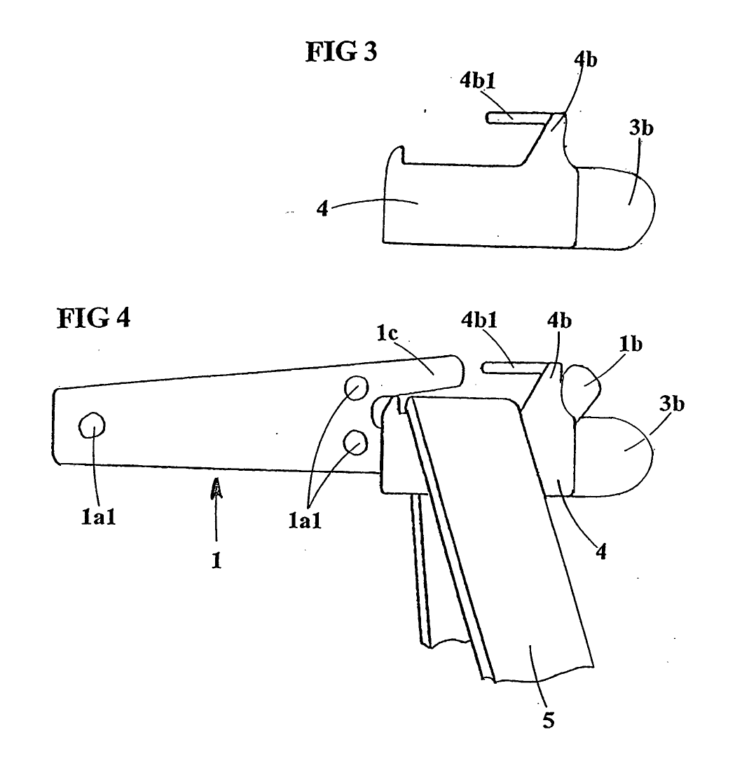

FIG. 3 shows a plan view from the side of an alternative embodiment according to the invention and FIG. 4 shows this in situ on the known safety element.

In FIGS. 1a, 1b, 1 generally denotes a safety element of known type. In this instance this is fitted partially concealed in the saddle, so that an arm 1a is visible in a hollow space 3 covered by a flap 2, the said arm usually being fitted to the saddle by riveting. For this purpose, the arm has through-openings 1a1 at one end. At its other, remote end a locking pin 1b is pivoted in the arm 1a.

The function of this known safety element is as follows: the stirrup strap 5 of the stirrup runs over the arm 1a and in normal riding is prevented by the upward pointing locking pin 1b from slipping off the latter.

In order to eliminate or at least mitigate the effect of the disadvantages referred to in the introductory part, according to the invention a sleeve 4, which has an elongated through-opening 4a for the stirrup leather 5, and a projection 4b at its end facing the locking pin, is introduced over the arm 1a and the locking pin 1b. In normal riding the said projection is designed to bear against the outer end 1b1 of the upwardly directed locking pin 1b.

In abnormal circumstances, that is to say when the stirrup leather is pulled obliquely backwards, as shown in FIG. 2, the locking pin 1b is exposed to a force, which forces it to be turned backwards so that ultimately the sleeve 4 can slip off the arm 1a, thereby releasing the stirrup released from the saddle. It will be noted that the force made to act on the locking pin 1b via the projection 4b acts as far away as possible from the bearing point of the locking pin 1b in the arm 1a, thereby achieving the greatest possible lever moment and hence the most reliable release function possible.

As already stated, the safety element 1 in this embodiment can be sunk in the hollow space 3, the edge 3a of which is intended to be capable of preventing the sleeve 4a being pulled off the arm 1a. For this purpose the sleeve has a tongue 3b. This is designed so that it extends past the leather edge 3a of the hollow space 3 and thereby reliably prevents the sleeve 4 from catching in the leather edge 3a

In the alternative embodiment of the device according to the invention, shown in FIG. 3, the sleeve 4 is intended to be at least partially surrounded by the stirrup leather 5, this in use being held in place between a projection 1c of the safety element 1 and an elongate pin 4b1 on the projection 4b. When the stirrup leather under abnormal circumstances is pulled obliquely backwards, it is released in the same way as explained in connection with the embodiment of the device according to the invention as first described.

1. Device in a riding saddle for fixing stirrup leathers (5) belonging to the saddle comprising a safety element (1) on each side of the saddle, which elements are designed as a mirror image of one another and fitted to the saddle, each comprising an arm (1a), which at its remote end has a pivoted locking pin (1b), the arm (1a) when riding being directed essentially horizontally backwards with the locking pin (1b) pointing upwards in order in normal riding to prevent a stirrup leather, running over the arm, (1a) from leaving this, but under increased stress as a result of abnormal circumstances being bent backwards, thereby allowing the stirrup leather (5) to be released, wherein the device comprises a sleeve (4) that can be threaded on to the arm (1a) and to which the stirrup leather (5) can be connected, and which at its end facing the remote end of the arm (1a) has a projection (4b), designed in normal riding to bear against the outer end (1b1) of the upwardly directed locking pin (1b), in order under abnormal circumstances to bend this backwards, thereby allowing the sleeve (4) to slip off the arm (1a) and thus free each stirrup from the saddle.

2. Device according to claim 1, in which the saddle has a hollow space (3) intended for the safety element (1) and with leather edge (3a) extending essentially across the arm (1a), wherein the sleeve (4) has a tongue (3b) extending backwards past the edge (3a), the function of which tongue is to prevent the sleeve (4) catching in the leather edge (3a).

3. Device according to claim 1, wherein the sleeve (4) has a cut-out (4a), by means of which the stirrup leather (5) can be connected to the sleeve (4).

4. Device according to claim 1, wherein the stirrup leather (5) is designed to at least partially surround the sleeve (4) in order to thereby be connected to the latter.
